(19) United States
(12) Patent Application Publication
(10) Pub. No.: US 2005/0078620 A1
(43) Pub. Date: Apr. 14, 2005

(54) Mobile-terminal gateway

(76) Inventors: Kumar Balachandran, Cary, NC (US); Anders Wesslen, Staffanstorp (SE)

Correspondence Address: JENKENS & GILCHRIST, PC, 1445 ROSS AVENUE, SUITE 3200, DALLAS, TX, 75202, US

(21) Appl. No.: 10/857,320

(22) Filed: May 27, 2004

Related U.S. Application Data
(60) Provisional application No. 60/510,578, filed on Oct. 10, 2003.
(60) Provisional application No. 60/510,558, filed on Oct. 10, 2003.

(51) Int. Cl. H04Q 7/00

(52) U.S. Cl. 370/313

(57) ABSTRACT

A mobile terminal includes an access subsystem and an application subsystem. The access subsystem includes at least one access-technology interface. The application subsystem is inter-operably connected to the access subsystem. The application subsystem and the access subsystem are separated via a functional split. The access subsystem provides access by the application subsystem to a first wireless network via a first access-technology interface of the at least one access-technology interface. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### CROSS-REFERENCE TO RELATED APPLICATIONS

This patent application claims priority from and incorporates by reference the entire disclosures of: 1) U.S. Provisional Patent Application No. 60/510,578, filed on Oct. 10, 2003 and bearing Docket No. 53807-00083USPL; and 2) U.S. Provisional Patent Application No. 60/510,558, filed on Oct. 10, 2003 and bearing Docket No. 53807-00084USPL. This patent application incorporates by reference the entire disclosure of U.S. patent application Ser. No. 10/359,835, filed on Feb. 7, 2003 and bearing Docket No. 53807-00045USPT. This patent application incorporates by reference the entire disclosure of a U.S. patent application entitled Method of and System for Scalable Mobile-Terminal Platform, filed on the same date as this patent application and bearing Docket No. 53807-00084USPT.

### BACKGROUND OF THE INVENTION

1. Technical Field

The present invention relates generally to a mobile-terminal architecture and, more particularly, but not by way of limitation, to a mobile-terminal architecture that employs a gateway that uses a functional split between access and application functionalities.

2. History of Related Art

In the future, mobile terminals are expected to continue to increase in capability in terms of both functionality and applications supported. Mobile terminals include, for example, cellular telephones, personal digital assistants (PDAs), and other personal handheld computers. Over time, the cellular telephone has tended to converge with the personal computer (PC). One significant impact of this convergence is the need for mobile terminals to become more expandable in the kind of hardware that a network can interface to and in software that may be run on the mobile terminal.

There are two primary views about architecting third-generation (3G) mobile terminals. The first is a computer-centric one, in which access to a cellular network is a peripheral function and emphasis is given to an application platform as the center of an architecture of the mobile terminal. In the computer-centric view, the presence of the cellular network is an afterthought, a mere added functionality to a personal hand-held computer.

FIG. 1 is an illustration of a current typical computer-centric view of a mobile-terminal architecture as seen from a hardware perspective. In FIG. 1, a mobile terminal architecture 100 includes a mobile terminal 102 that includes various interfaces to external devices and components. The mobile terminal 102 includes an interface to a camera 104, a generic multimedia device 106, a USB device 108, a keyboard 110, and an LCD display 112 (via an LCD controller 114). Also shown connected to the mobile terminal 102 is an audio codec 116, which is connected via a PC or SPI interface and an i2S interface. In addition, the mobile terminal 102 interfaces with a power management block 118 via an i2C interface.

A NAND flash memory 120 is controlled by a NAND controller of the mobile terminal 102. The mobile terminal 102 also controls a mobile double data rate (DDR) memory 122 via an SDRAM controller. An IrDA 124 is controlled by an FlrDA of the mobile terminal 102, while a BLUETOOTH module 126 is connected to a UART of the mobile terminal 102. An antenna 128 serves the BLUETOOTH module 126. The mobile terminal 102 is also connected to a modem 130 via a modem interface of the mobile terminal 102. An antenna 132 serves the modem 130.

The mobile terminal architecture 100 is computer-centric, meaning that the various external devices and components connect to the mobile terminal 102 via a variety of interfaces in a fashion similar to that currently employed by PCs. The mobile terminal 102 is an example of a computer-centric mobile terminal presented by an industry alliance known as the Mobile Industry Processor Interface (MIPI) Alliance.

FIG. 2 illustrates a possible future system-bus-oriented computer-centric view of a mobile terminal architecture as seen from a hardware perspective. In FIG. 2, a mobile terminal architecture 200 includes a mobile terminal 202. The mobile terminal architecture 200 is different from the mobile terminal architecture 100 in one major respect, that being inclusion of a system bus 204. The system bus 204 may be used to connect a plurality of external devices to the mobile terminal 202. Thus, the mobile terminal architecture 200 may be termed a system-bus-oriented computer-centric architecture.

The system bus 204 is shown connecting the mobile terminal 202 to the modem 130, the BLUETOOTH module 126, the camera 104, the keyboard 110, the power management block 118, and a global positioning system (GPS) module 206. Also shown connected to the mobile terminal 202 are the NAND flash memory 120, the mobile DDR 122, the IrDA 124, the USB device 108, and the generic multimedia device 106. In addition, general purpose input/output (GPIOs) 208 are illustrated as part of the mobile terminal 202.

The system bus 204 serves to make the architecture 200 even more like a PC than the mobile terminal architecture 100; indeed, the architecture 200 represents the computer industry's view of an evolution path for mobile telephones. In particular, interfaces handled by the mobile terminal 202 (e.g., the USB 108) and the interfaces handled by the system bus 204 (e.g., the camera 104) are still organized in a computer-centric fashion. The architecture 200 may be used to create a delineation between various component manufacturers, thus exploiting synergies of cooperation and allowing industry partners to lower costs.

### SUMMARY OF THE INVENTION

A mobile terminal includes an access subsystem and an application subsystem. The access subsystem includes at least one access-technology interface. The application subsystem is inter-operably connected to the access subsystem. The application subsystem and the access subsystem are separated via a functional split. The access subsystem provides access by the application subsystem to a first wireless network via a first access-technology interface of the at least one access-technology interface.

A wireless-network access method includes providing a mobile terminal that includes an application subsystem and an access subsystem separated via a functional split. The method also includes accessing, by the application subsystem, of a first wireless network via a first access-technology interface of at least one access-technology interface of the access subsystem.

### BRIEF DESCRIPTION OF THE DRAWINGS

A more complete understanding of the present invention may be obtained by reference to the following Detailed Description of Exemplary Embodiments of the Invention, when taken in conjunction with the accompanying Drawings, wherein:

FIG. 1 is an illustration of a current typical computer-centric view of a mobile-terminal architecture as seen from a hardware perspective;

FIG. 2 illustrates a possible future system-bus-oriented computer-centric view of a mobile terminal architecture as seen from a hardware perspective;

FIG. 3 illustrates a network-centric view of interaction between a mobile-terminal user and various networks in accordance with a gateway architecture;

FIG. 4 illustrates an exemplary mobile terminal in accordance with the gateway architecture; and

FIG. 5 illustrates a wireless network that includes a server and gateway operating in a personal area network.

### DETAILED DESCRIPTION OF EXEMPLARY EMBODIMENTS OF THE INVENTION

Embodiment(s) of the present invention will now be described more fully with reference to the accompanying Drawings. The invention may, however, be embodied in many different forms and should not be construed as limited to the embodiments set forth herein. The invention should only be considered limited by the claims as they now exist and the equivalents thereof.

Advances in wireless technology and computing have led to an increasing need to connect personal devices with each other or to the outside world. For example, laptop computers, personal digital assistants (PDAs), cameras, accessories, and personal-entertainment devices are all devices that are vying for access to the Internet in primarily four spheres of the user's life. The four spheres are: 1) play; 2) work; 3) home; and 4) on the move. There is also a need to synchronize information in the mobile terminal to, for example, PDAs or personal information management (PIM) servers on a desktop personal computer or on the Internet.

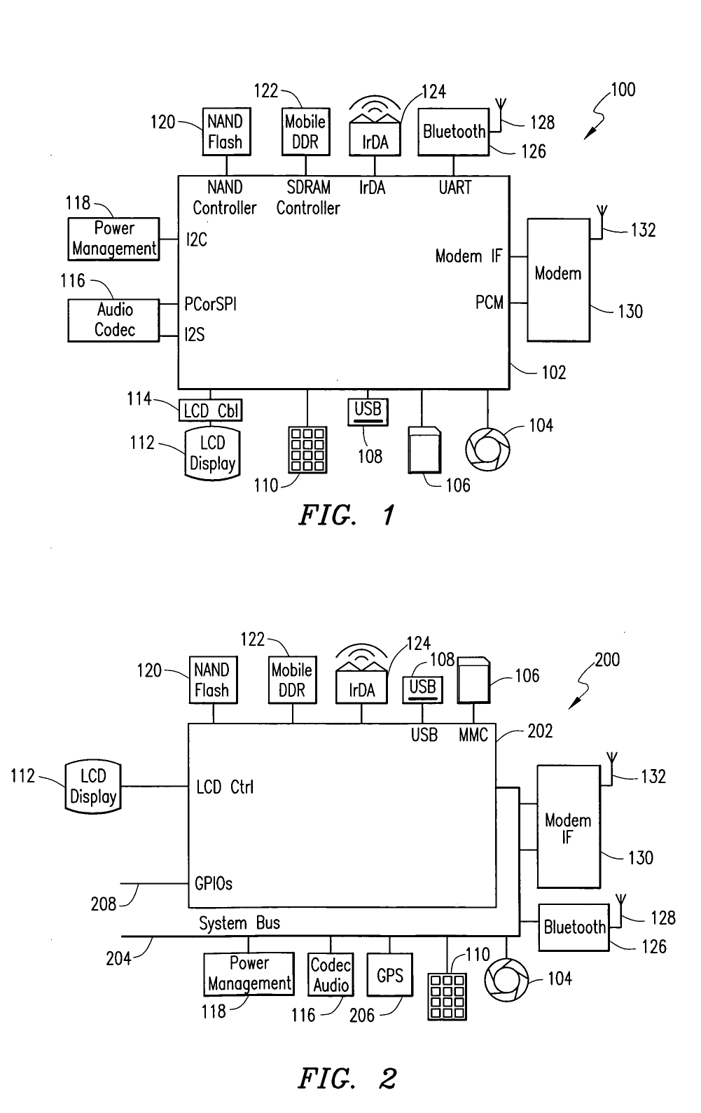

In contrast to the mobile-terminal architectures illustrated in FIGS. 1 and 2, a mobile-terminal architecture that does not assume any prescribed separation between handled interfaces possesses certain advantages. In a mobile terminal gateway architecture, a communications (i.e., access) subsystem and a peripheral subsystem of the mobile terminal are separated from an application subsystem, including an application processor, in a uniform way. The separation is consistent with, for example, basic protocols that underlie the Internet, and makes possible a distributed architecture for the mobile terminal. The gateway architecture allows a uniform separation between application functionality and access functionality of the mobile terminal to be made, while also making possible a personal area network (PAN) for multiple devices that may be carried by the user. In various embodiments of the invention, the mobile-terminal architecture is not viewed as a set of hardware modules that need to inter-operate with one another. Rather, in various embodiments of the invention, it is recognized that adding multiple communication interfaces to the architecture of a mobile terminal results in the ability to communicate being central to distribution of functionality.

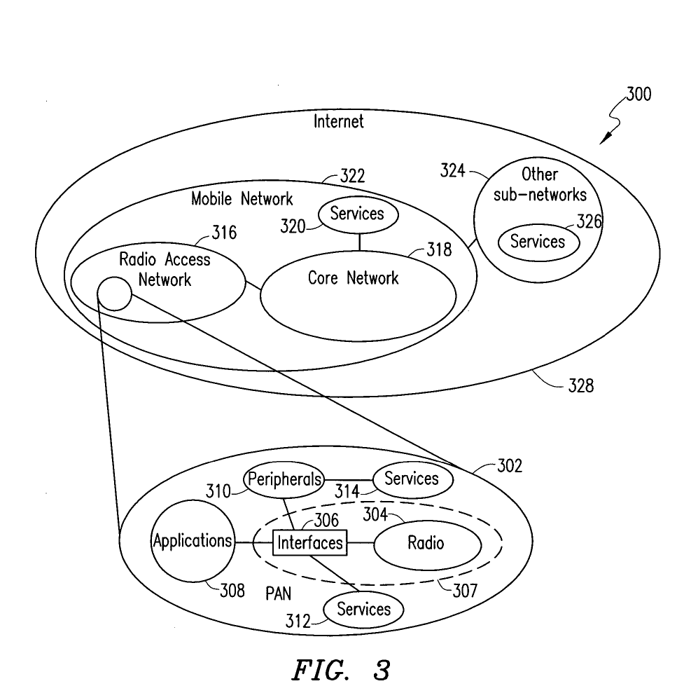

FIG. 3 illustrates a network-centric view of interaction between a mobile-terminal user and various networks in accordance with the gateway architecture. The view 300 includes a PAN 302 that represents the so-called personal space of the mobile-terminal user. For example, the PAN may be represented by an area of approximately 10 meters in radius surrounding the mobile terminal. The PAN 302 includes a radio part 304 of a mobile terminal of the user. Connected to the radio part 304 are a plurality of interfaces 306. The interfaces 306 and the radio part 304 together form an access subsystem 307. A mobile terminal operating in the PAN 302 includes the application subsystem 308 and the access subsystem 307. The interfaces 306 interconnect one or more of the radio part 304, the application subsystem 308, peripherals 310, and services 312 that are accessible from within the PAN 302. Also shown are services 314 accessible via the interfaces 306 and the peripherals 310.

The PAN 302 is part of a radio access network 316. The radio access network 316 is connected to a core network 318. The core network 318 permits access to core network services 320. The radio access network 316, which includes the PAN 302, and the core network 318 are part of a mobile network 322. The mobile network 322 is connected to other subnetworks 324, which include various services 326. The mobile network 322 and the other subnetworks 324 are part of the Internet 328. The PAN 302, the radio access network 316, the mobile network 322, and the Internet 328 represent ever-increasing circles of functional interaction between the mobile-terminal user and the mobile-terminal user's environment.

The application subsystem 308 and the peripherals 310 may access other entities via the access subsystem 307, which acts as a router or gateway. The other entities may be within the PAN 302, the radio access network 316, the mobile network 322, or the Internet 328.

Unlike prior approaches, a wireless network (e.g., the PAN 302) is the center of the gateway architecture and applications (either on the application subsystem 308 or on the peripherals 310) are participants in interactions of the user via the wireless network with intelligence in the form of services or other users. The mobile-terminal user's connection with the wireless network may thus be seen as arising out of ever-increasing circles of influence. The network-centric view 300 has profound implications for the software and hardware architecture of mobile terminals that employ the gateway architecture.

The gateway architecture enables manufacture of a mobile terminal that is, in effect, a router in the mobile network 322. The mobile terminal serves as a hub for the PAN 302 and provides the mobile-terminal user with flexibility to route information between various applications and personal devices or peripherals and the mobile network 322, both within and external to the PAN 302 and/or the mobile network 322.

The gateway architecture capitalizes on a separation between the application subsystem 308 and the access subsystem 307. An access-application separation, which may also be referred to as a functional split, is discussed in a U.S. patent application entitled Method of and System for Scalable Mobile-Terminal Platform System, filed on the same date as this patent application and bearing Docket No. 53807-00084USPT.

Third-generation access technologies provide a service infrastructure for both the mobile terminal and for other devices. Many services yield higher quality when accessed from more-capable devices; for example, services that benefit from a more capable device include streaming audio and streaming video. The PAN 302 offers the same service to all devices connected to the PAN. In addition, services on each device can be easily distributed to all other PAN 302 devices. The PAN 302 is also scalable. The functionality of the gateway depends on the number of devices that can connect to the PAN 302 (i.e., the number of interfaces available) and on the gateway's capacity. The smallest configuration only has one device and the access subsystem 304 as nodes of the PAN 302. The device can either be the application subsystem 308 or another device (e.g., in a telematics solution). In a larger configuration, the PAN 302 may be limited only by the capacity (i.e., packets/s) of the access subsystem 307.

The gateway architecture results in an architecture that is very different from that of either of FIG. 1 or 2. In accordance with the gateway architecture, the access-application separation is, in essence, a separation between access functionality and application functionality. The gateway architecture employs distributed-processing concepts and a network-centric view of the mobile terminal.

If a separation of the access functionality and the application functionality is implemented in two separate processors, the access subsystem 307 may handle common access (i.e., communication) services and the application subsystem 308 may handle end-user needs in a flexible and upgradeable fashion. Splitting the application functionality and the access functionality is intended to achieve the following: 1) isolation of functionality and consequent optimization of design of the access subsystem 307 and the application subsystem 308; 2) mobile-terminal versatility at a small increase in cost, such that the application subsystem 308 can, for example, scale with applications used by the mobile terminal and the access subsystem 307 can, for example, scale with network-access capabilities of the mobile terminal; and 3) enhanced control over access functionality to a mobile-terminal-platform developer.

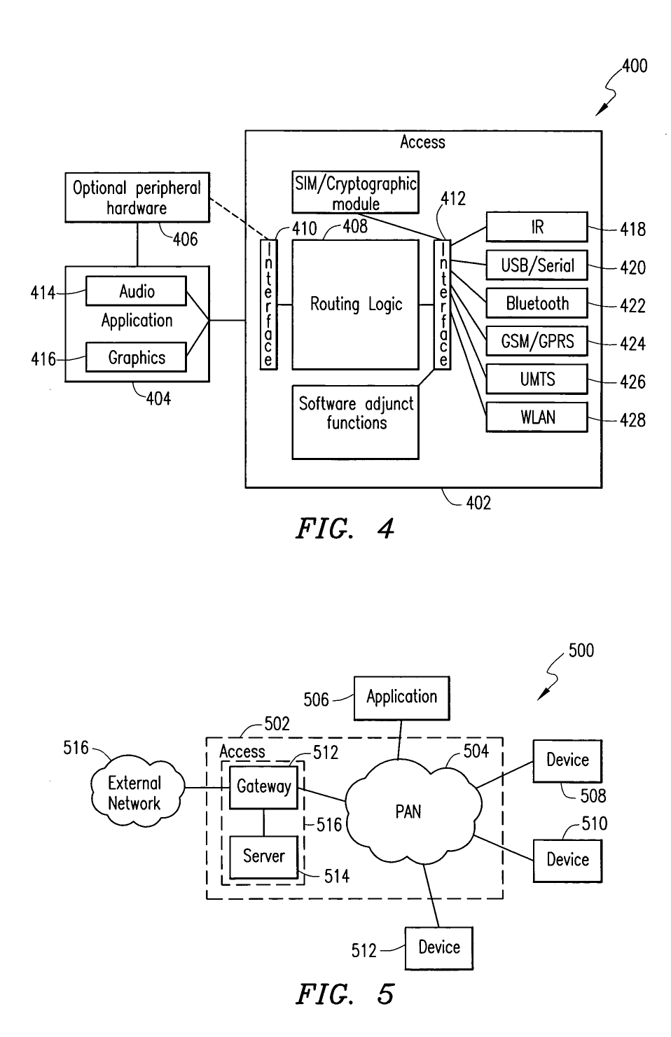

FIG. 4 illustrates an exemplary mobile terminal in accordance with the gateway architecture. The mobile terminal 400 includes an access subsystem 402, an application subsystem 404, and optional peripheral hardware 406. The access subsystem 402 serves as a gateway that allows a user of the mobile terminal 400 to access the application subsystem 404, the optional peripheral hardware 406, as well as any other devices within the PAN 302 of the mobile-terminal user. The application subsystem 404 includes an audio interface 414 and a graphics interface 416. The access subsystem includes routing logic 408, an interface 410 to the application subsystem 404, and an interface 412 to various access-technology interfaces. The various access-technology interfaces include IR 418, USB/serial 420, BLUETOOTH 422, GSM/GPRS 424, UMTS 426, and WLAN 428.

In contrast to FIG. 4, in a traditional view of separation of duties within a mobile terminal, an access functionality is, in effect, merely a modem serving an application functionality. FIGS. 1 and 2 represent variations of the traditional view. The traditional view comes from the PC world (e.g., operating system (OS) manufacturers and application developers), in which the modem is treated as a peripheral slaved to the PC. In contrast to the traditional view, the gateway architecture permits network access devices to be built that may be integrated with application engines for various devices. The access subsystem 402 provides added value to device developers and provides a more-optimized connectivity solution than that of a mere modem.

In addition to the application subsystem 404, which is typically integrated into the mobile terminal 400, other devices within the PAN 302 may also obtain access, via the access subsystem 402, to external networks (e.g., the Internet). In the gateway architecture, the application subsystem 404 and all other devices that can connect to the PAN 302 can access services in the access subsystem 402, or in other connected devices via the access subsystem 402. Within the PAN 302, the access subsystem 402 routes data to the proper receiving device or serves requests for services from devices in the PAN 302. Devices may also be connected via the access subsystem 402 to the external world via various standard wireless technologies, such as, for example, UMTS, GSM/GPRS, EDGE or W-LAN. In various implementations of the gateway architecture, the only major difference between the application subsystem 404 and the other devices (e.g., the optional peripheral hardware 406) connected to the PAN 302 is that the application subsystem 404 is typically integrated into the mobile terminal 400 itself and uses a different interface (i.e., hardwired) to the access subsystem 402.

The application-access functional split need not be a purely hardware split, although mobile terminals using the gateway architecture may have a physical separation of computing resources for application services and access services on separate processors. The split between access functionality and application functionality allows the application subsystem 404 and the access subsystem 402 to complement each other and to borrow from each other's functionality. In addition, functional interfaces between applications and services in various components of the PAN 302 may be defined so as to allow uniformity of access, regardless of whether the various components are separated as software processes, hardware components in the mobile terminal 400, or hardware devices completely removed from the mobile terminal 400.

FIG. 5 illustrates a wireless network that includes a server and gateway operating in a personal area network. A network 500 includes an access subsystem 502 including a PAN 504 connected to an application subsystem 506 and external devices 508, 510, and 512. The access subsystem 502 includes a gateway 512 and an access server 514. The access server 514 is the access point for access-subsystem services and may be accessed by any entity within the PAN 504 seeking the services housed thereon. The gateway 512 and the access server 514 are shown as included within a box 516, since the gateway 512 and the access server 514 are typically logical entities implemented in the same physical entity. A mobile terminal includes the access subsystem 502 and the application subsystem 506. The gateway 512 permits user access to an external network 516 by any of the application subsystem 506 or the devices 508, 510 or 512.

The access subsystem 502 provides a networking hub for access via the PAN 504 to external networks as well as a router for the PAN 504. In some mobile terminals employing the gateway architecture, the application subsystem 506 is considered just another device on the PAN 504, as illustrated in FIG. 5. In other mobile terminals that employ the gateway architecture, an application subsystem and an access subsystem together form a PAN gateway, and remote devices (i.e. devices external to the mobile terminal) are viewed identically from the perspective of the PAN gateway. In either case, access-subsystem services are accessible via an access server over the relevant PAN.

Communications within a PAN may occur via TCP/IP, as TCP/IP offers a standard communication interface, most operating systems providing a socket application programming interface (API). Building services on top of the socket API permits the services to be device and operating-system independent. Because the gateway architecture may be made application-operating-system independent, communications with services are not necessarily dependent on the application operating system used. Thus, a gateway may be built on facilities that most operating systems are likely to support, such as, for example, a socket API. However, if an application operating system determines that a socket API is for some reason insufficient, the application operating system may, if design constraints dictate, determine how the pertinent functionality is to be implemented and rule out a socket API implementation.

For example, a real-time operating system from ENEA, called OSE, provides mechanisms for inter-process communications using message-passing constructs such as signals, semaphores, and shared memory. Thus, in a platform that uses a single processor to implement application functionality and access functionality, or in a mobile terminal that uses a plurality of processors all running OSE, the socket API could be bypassed and an entire functional separation implemented using low-level operating-system constructs. Various embodiments of the invention aim to encourage standardized interfaces that permit low-level calls to be abstracted via a socket API to the low-level calls. Thus, in various embodiments of the invention, a standard socket API may be mapped to a proprietary protocol family that interfaces to inter-processor communication facilities. In addition, in various embodiments of the invention, the standard socket API may be mapped into another link layer such as, for example, one provided by a specialized serial link such as the MSL or a profile based on a non-IP one provided by, for example, BLUETOOTH. Further, in various embodiments of the invention, the socket API may communicate with server functions that can, in turn, set up non-IP routing protocols for some kinds of traffic, such as, for example, voice for telephony. In various embodiments of the invention, a functional separation between access functionality and application functionality does not depend upon conventional views of the particular ways in which the functionalities are implemented via hardware and/or software.

Under circumstances in which most external networks that the access subsystem can connect to are based on TCP/IP, use of TCP/IP for a PAN is a logical choice. Under most circumstances, use of a non-IP-based solution requires some type of access-subsystem translation gateway. A TCP/IP stack is often implemented in devices such as, for example, laptops and PDAs.

If IP is to be used for communications within a PAN, one of the major problems with IPv4 is the diminishing availability of addresses. Network Address Translation (NAT), Internet Connection Sharing (ICS), or masquerading under Linux commonly solves the shortage of IPv4 addresses. NAT allows a private network to share a single external IP address. The internal network uses non-routable IP addresses as are specified in IETF RFC 1918. In its simplest form, NAT merely translates IP addresses; however, the simplest form of NAT is seldom implemented. The most common form of NAT is officially termed NAT with port translation (NATPT). In NATPT, translation is enabled of IP addresses and port addresses between internal and external networks.

Despite the above, some applications need an end-to-end connection, which NAT breaks. One common way of solving this problem is to use application-level gateways (ALGs), which parse incoming packets and re-package content and send the repackaged content to its destination. The ALGs are tailored for each application (e.g., FTP) and must be implemented in the gateway. The complexity and resource requirements of an ALG depend on the application. In addition, Quality of Service (QoS) for different packet data protocol (PDP) contexts cannot be handled in an IP communication. To sort packets to different PDP contexts, packet filtering is needed in the gateway.

Prioritization of data transport may be altered via use of QoS provisioning. At lower levels, interfaces such as Intel's MSL provide the ability to alter QoS on several logical channels carried over one hardware interface. At higher levels, modern operating systems provide facilities such as Microsoft's Generalized Quality of Service (GQOS) or standardized protocols such as the Resource Reservation Protocol (RSVP), which may be used to manage prioritization of data support. In practice, several fixed QoS profiles are typically attached to each available logical channel and application requirements are mapped to the best available profile. Data and control links may be similarly differentiated.

The address-space issue present when IPv4 is used is not a problem with IPv6. In IPv6, addresses are 128 bits instead of 32 bits, which means that there are a sufficient number of addresses to let each device have its own global IP address. Thus, when the gateway is connected to the external network, the gateway obtains a sub-net of global addresses for the internal network. With global addresses, the NAT and the ALGs are no longer required.

However, when an IPv6 PAN is implemented, external access may still be an IPv4 connection. There are at least two options to solve the connections to the external network: 1) use of a NAT/ALG solution; 2) tunneling the IPv4 traffic over the PAN. The first solution is discussed above. The second solution has the disadvantage that only one node of the PAN can connect to the external network at a time.

With IPv6, there is no need for a dynamic host control protocol (DHCP) server in the PAN, as the local IPv6 network implements stateless auto-configuration. In addition, when IPv6, rather than IPv4, is used, the access subsystem tends to be more independent of the application subsystem, as there is no need for implementing application-specific ALGs. Moreover, IPv6 adds quality-of-service (QoS) capabilities, so senders can request, and devices can apply, special handling to different kinds of traffic. Making QoS information explicit helps routers process packets more quickly, making it easier, for example, to give real-time multimedia higher QoS than default, while simple file transfers might get even lower QoS. While basing the PAN 302 on IPv6 possesses certain advantages discussed above, the PAN may be based on any suitable protocol.

An example of an advantage of the gateway architecture is when an access subsystem provides voice compression functionality for telephony and multimedia. An application developer need not repeat the voice compression functionality if the compression library on the access subsystem is available as a functional interface to the application subsystem or other devices in the PAN. Thus, useful parts of the access subsystem may be exposed to the application subsystem and other devices in the PAN, such as, for example, (e.g., a voice memo application) without significant software development.

As another example, an advanced application subsystem may be capable of some of the networking functionality that the access subsystem typically provides. Thus, a functional component such as DHCP may actually be removed from the access subsystem and migrated to the application subsystem, while exposing the functionality within the access environment.

As another example, the GSM specification requires the use of a Subscriber Identity Module (SIM) to store subscriber-specific information that allows migration of information such as, for example, subscriber identity and phonebook data from one terminal to another. The exposure of specific functional interfaces towards the SIM allows more sophisticated personal information databases on an application subsystem to be synchronized on a real-time basis with an access subsystem.

As another example, advanced mobile devices such as smart phones or PDAs may have a focus towards gaming and other multimedia applications. The gateway architecture allows migration of hardware interfaces, such as audio or graphics, outside of an access subsystem, so that the gateway architecture can easily be scaled. Thus, the access subsystem implemented using a baseband processor with rudimentary graphics and audio functionality meant for basic cellular phones may be used along with more advanced application environments in a way that allows the multimedia peripheral functionality to be migrated to access a new application environment.

Middleware services that permit application developers to access both an application subsystem and an access subsystem may be exported via a set of interfaces and related functionality termed an Open Platform API (OPA). The OPA is, in turn, part of an overall middleware block (not shown) separating third-party application software from platform services software (i.e., application subsystem software and access subsystem software). The OPA represents platform functionality that customers can use to develop applications. The OPA functionality relies on an execution model introduced in the middleware block.

When a standard operating subsystem is used by an application subsystem, the OPA may implement communications for access-subsystem functionality via a socket API, which can be used to hide proprietary methods, such as, for example, operating-system-specific inter-process communication facilities such as, for example, link handlers in OSE or non-TCP/IP protocol families associated with other types of link layer protocols. Within each of the application subsystem and the access subsystem, process communications may be based on the link handler. Applications built on top of the OPA see no difference between the application subsystem and the access subsystem.

For external operating systems loaded on the application subsystem, only the access functionality of the OPA may be supported in an effort to minimize external operating system support. In such cases, the OPA may be modified for each different application operating system or a description of how to access the access services over the sockets API may be provided. The choice is between a functional interface (i.e., OPA) or a message-based interface (i.e., sockets). Software control and configuration of the access subsystem and the application subsystem may be performed by a sockets based interface. For example, an SNMP/TCP/IP-based access may be provided.

An access subsystem can scale from a low-end to a high-end device. The access subsystem typically scales with three parameters: 1) the number of external interfaces; 2) the throughput (packets/s); and 3) the services the access subsystem provides. If an IP solution is used, a TCP/IP stack may be located on both the access subsystem and the application subsystem. If a PAN is based on IPv6, the devices connecting to the PAN may not need to implement both IPv4 and IPv6; however, whether IPv4 support is needed depends on how a possible external IPv4 connection will be handled.

Telematics solutions are used when connectivity is added to embedded devices, such as, for example, automotive systems or beverage machines. The gateway architecture provides a self-contained access subsystem with a standard interface and protocol to access the access subsystem. The choice of interface can be any of the external interfaces supported by the access subsystem.

As described above, the gateway may be implemented so that the application subsystem is viewed as merely another device among others in the PAN 302. When the application subsystem is so viewed, services that depend on the real-time aspects of the IP stack may suffer performance degradation. One potential example is delivery of audio data between the access subsystem and the application subsystem. In order to achieve sufficient performance, the IP stack needs to possess acceptable throughput, latencies, and variations in the latencies.

One way to avoid potential performance degradation of the services that depend on real-time aspects of the IP stack is to tie the application subsystem more tightly to the access subsystem. In such a case, the application subsystem is no longer viewed merely as another node in the PAN. Rather, in the audio-data example mentioned above, a special audio data path can be established via a direct channel over a logical interface between the application subsystem and the access subsystem and only control transmitted over IP. The application subsystem is thus treated differently than other devices connected to the PAN. In such a case, if the application subsystem is not treated differently than the other devices, the access subsystem supports the direct channel for every supported external interface.

An extreme of tighter integration between the access subsystem and the application subsystem is when the access subsystem and the application subsystem together form the gateway and communications therebetween occur via a specialized protocol, such as, for example, the link manager in OSE. A PAN then includes the mobile terminal as one node and other devices connected through external interfaces of the mobile terminal as other nodes. Another option is to optimize a communications channel between the gateway and the PAN devices by, for example, removing the IP stack and implementing a socket API directly about the external interface. Thus, there will be one implementation for each of the external interfaces.

In contrast to the tighter integration discussed above, when the application subsystem is viewed by the gateway as merely another device in a PAN, any device that can connect to the PAN may be considered the application subsystem of the mobile terminal. The PAN may, but need not necessarily, be based on the IP protocols. The access subsystem forms a self-contained access device whose services may be accessed via, for example, the socket API.

The previous Description is of embodiment(s) of the invention. The scope of the invention should not necessarily be limited by this Description. The scope of the present invention is instead defined by the following claims and the equivalents thereof.

1. A mobile terminal comprising:
an access subsystem, the access subsystem comprising at least one access-technology interface;
an application subsystem inter-operably connected to the access subsystem;
wherein the application subsystem and the access subsystem are separated via a functional split; and
wherein the access subsystem provides access by the application subsystem to a first wireless network via a first access-technology interface of the at least one access-technology interface.

2. The mobile terminal of claim 1, further comprising:
a plurality of service components;
wherein each of the plurality of service components is inter-operably connected to at least one of the access subsystem and the application subsystem; and
wherein the plurality of service components provide access to functionality required by at least one of the access subsystem and the application subsystem.

3. The mobile terminal of claim 2, wherein the plurality of service components comprise separable hardware modules.

4. The mobile terminal of claim 2 wherein the plurality of service component comprise separable software modules.

5. The mobile terminal of claim 2, wherein the service components comprise a combination of hardware components and software components.

6. The mobile terminal of claim 1, wherein the access subsystem and the application subsystem communicate via Berkeley Software Distribution (BSD) sockets.

7. The mobile terminal of claim 1, wherein communications between the access subsystem and the application subsystem occur via the Internet Protocol.

8. The mobile terminal of claim 7, wherein the Internet Protocol is IPv4.

9. The mobile terminal of claim 7, wherein the Internet Protocol is IPv6.

10. The mobile terminal of claim 1, further comprising:
an external device located within a personal area network of the mobile terminal and inter-operably connected to the access subsystem; and
wherein the access subsystem provides access by the external device to a second wireless network via a second access-technology interface of the at least one access-technology interface.

11. The mobile terminal of claim 10, wherein the access subsystem inter-operably connects the application subsystem and the external device to one another.

12. The mobile terminal of claim 10, wherein:
the access provided by the access subsystem via the second access-technology interface is within the personal area network; and
the access subsystem provides access by the external device to a third wireless network, the third wireless network including an area outside the personal area network.

13. The mobile terminal of claim 1, wherein the access subsystem serves as a wireless router that connects at least one external device inter-operably connected to the access subsystem to a second wireless network.

14. The mobile terminal of claim 13, wherein the application subsystem and the at least one external device are inter-operably connected to one another via the access subsystem.

15. The mobile terminal of claim 1, wherein the access subsystem and the application subsystem communicate via a sockets-based interface.

16. The mobile terminal of claim 15, wherein the sockets-based interface is in accordance with Berkeley Software Distribution (BSD) sockets.

17. The mobile terminal of claim 15, wherein a link-specific address and protocol family for a socket library are utilized.

18. The mobile terminal of claim 1, further comprising:
a middleware;
wherein the middleware provides access by an application developer to the access subsystem and to the application subsystem; and
wherein the functional split is hidden from the application developer via an application-programming interface.

19. The mobile terminal of claim 1, wherein capabilities of the access subsystem are made available to the application subsystem for use by applications executed via the application subsystem.

20. The mobile terminal of claim 19, wherein the capabilities comprise at least one of hardware functionality and software functionality.

21. The mobile terminal of claim 1, wherein capabilities of the application subsystem are made available to the access subsystem for use by the access subsystem.

22. The mobile terminal of claim 21, wherein the capabilities comprise at least one of hardware functionality and software functionality.

23. The mobile terminal of claim 1, wherein a network management tool is used to configure and control functions provided by at least one of the access subsystem and the application subsystem.

24. The mobile terminal of claim 23, wherein the network management tool is in accordance with the Simple Network Management Protocol (SNMP).

25. The mobile terminal of claim 1, wherein prioritization of data transmitted between the access subsystem and the application subsystem occurs via quality of service (QoS) provisioning.

26. The mobile terminal of claim 1, wherein the access subsystem is adapted to be implemented without the application subsystem in a telematics application.

27. The mobile terminal of claim 1, wherein the access subsystem comprises at least one of a voice codec and a video codec and the application subsystem is adapted to transparently access the at least one voice codec or video codec.

28. The mobile terminal of claim 1, wherein the access subsystem comprises subscriber identity module (SIM) functionality and the application subsystem is adapted to transparently access the SIM functionality of the access subsystem.

29. The mobile terminal of claim 1, wherein at least one of the access subsystem and the application subsystem comprises a voice compression library.

30. The mobile terminal of claim 1, wherein the mobile terminal comprises a global positioning system (GPS) module.

31. The mobile terminal of claim 30, wherein the GPS module is adapted to be used by the application subsystem.

32. The mobile terminal of claim 30, wherein the GPS module is adapted to be used by the access subsystem for assisted GPS location.

33. A wireless-network access method comprising:
providing a mobile terminal, the mobile terminal comprising an application subsystem and an access subsystem separated via a functional split;
accessing, by the application subsystem, of a first wireless network via a first access-technology interface of at least one access-technology interface of the access subsystem.

34. The wireless-network access method of claim 33, further comprising:
providing a plurality of service components;
inter-operably connecting the plurality of service components to at least one of the access subsystem and the application subsystem; and
providing, via the plurality of service components, access to functionality required by at least one of the access subsystem and the application subsystem.

35. The wireless-network access method of claim 34, wherein the plurality of service components comprise separable hardware modules.

36. The wireless-network access method of claim 34, wherein the plurality of service components comprise separable software modules.

37. The wireless-network access method of claim 34, wherein the plurality of service components comprise a combination of hardware components and software components.

38. The method of claim 33, wherein the accessing step comprises the access subsystem and the application subsystem communicating via Berkeley Software Distribution (BSD) sockets.

39. The method of claim 33, wherein the accessing step comprises the access subsystem and the application subsystem communicating via the Internet Protocol.

40. The method of claim 39, wherein the Internet Protocol is IPv4.

41. The method of claim 39, wherein the Internet Protocol is IPv6.

42. The method of claim 33, further comprising an external device accessing, via the access subsystem, of a second wireless network via a second access-technology interface of the at least one access-technology interface.

43. The method of claim 42, wherein the external device accessing step comprises the access subsystem inter-operably connecting the application subsystem and the external device to one another.

44. The method of claim 42, further comprising:
wherein the access provided by the access subsystem via the second access-technology interface is within the personal area network; and
providing, by the access subsystem of access by the external device to a third wireless network, the third wireless network including an area outside the personal area network.

45. The method of claim 33, further comprising the access subsystem serving as a ireless router to connects at least one external device inter-operably connected to the access subsystem to a second wireless network.

46. The method of claim 45, wherein the application subsystem and the at least one external device are inter-operably connected to one another via the access subsystem.

47. The method of claim 33, wherein the access subsystem and the application subsystem communicate via a sockets-based interface.

48. The method of claim 47, wherein the sockets-based interface is in accordance with Berkeley Software Distribution (BSD) sockets.

49. The method of claim 47, wherein a link-specific address and protocol family for a socket library are utilized.

50. The method of claim 33, further comprising:
providing access by an application developer to the access subsystem and to the application subsystem; and
wherein the functional split is hidden from the application developer via an application-programming interface.

51. The method of claim 33, further comprising providing capabilities of the access subsystem to the application subsystem for use by applications executed via the application subsystem.

52. The method of claim 51, wherein the capabilities comprise at least one of hardware functionality and software functionality.

53. The method of claim 33, further comprising providing capabilities of the application subsystem to the access subsystem for use by the access subsystem.

54. The method of claim 53, wherein the capabilities comprise at least one of hardware functionality and software functionality.

55. The method of claim 33, further comprising using a network management tool to configure and control functions provided by at least one of the access subsystem and the application subsystem.

56. The method of claim 55, wherein the network management tool is in accordance with the Simple Network Management Protocol (SNMP).

57. The method of claim 33, further comprising prioritizing data transmitted between the access subsystem and the application subsystem via quality of service (QoS) provisioning.

58. The method of claim 33, wherein the access subsystem is adapted to be implemented without the application subsystem in a telematics application.

59. The method of claim 33, wherein the access subsystem comprises at least one of a voice codec and video codec and the application subsystem is adapted to transparently access the at least one voice codec or video codec.

60. The method of claim 33, wherein the access subsystem comprises subscriber identity module (SIM) functionality and the application subsystem is adapted to transparently access the SIM functionality of the access subsystem.

61. The method of claim 33, wherein at least one of the access subsystem and the application subsystem comprises a voice compression library.

62. The method of claim 33, wherein the mobile terminal comprises a global positioning system (GPS) module.

63. The method of claim 62, wherein the GPS module is adapted to be used by the application subsystem.

64. The method of claim 62, wherein the GPS module is adapted to be used by the access subsystem for assisted GPS location.

65. A mobile terminal comprising:
means for providing access to a first wireless network via a first access-technology interface;
means for executing applications;
wherein the means for providing access and the means for execution applications are separated via a functional split; and
wherein the means for providing access provides access by the means for executing applications to the first wireless network via the first access-technology interface.
